(19) United States
(12) Patent Application Publication
(10) Pub. No.: US 2014/0193850 A1
(43) Pub. Date: Jul. 10, 2014

(54) HOLOGRAPHIC METHOD AND DEVICE FOR CYTOLOGICAL DIAGNOSTICS

(71) Applicants: Serge Jooris, Brussels (BE); Philip Mathuis, Brussels (BE)

(72) Inventors: Serge Jooris, Brussels (BE); Philip Mathuis, Brussels (BE)

(73) Assignee: OVIZIO IMAGING SYSTEMS NV/SA, Brussels (BE)

(21) Appl. No.: 14/233,580

(22) PCT Filed: Jul. 16, 2012
(86) PCT No.: PCT/EP2012/063935

§ 371 Date: Feb. 19, 2014

(30) Foreign Application Priority Data
Jul. 19, 2011 (EP) 11174583.2

(51) Int. Cl. G01N 21/45

(52) U.S. Cl. CPC G01N 21/453
USPC 435/29; 435/288.7

(57) ABSTRACT

The present invention discloses a method for analyzing a liquid cell sample, comprising the steps of: a) providing at least one liquid cell sample in a sample vial; b) obtaining data linked to the cells in the sample by performing differential digital holographic microscopy on said liquid cell sample in said sample vial. In a second aspect, the invention also provides for a system for analyzing a liquid cell sample, comprising (i) a differential digital holographic microscope comprising illumination means, a differential interferometer and a digital recording device connected to a processing device such as a computer; (ii) at least one exchangeable sample vial comprising a liquid cell (iii) a movable sample vial holder; characterized in that (iv) said sample vial holder is adapted to receive said sample vial; (v) said sample vial holder is adapted to position said sample vial such that the focal plane of the objective lens of said differential digital holographic microscope lies in the vial.

### TECHNICAL FIELD

The present invention pertains to the technical field of cytopathology, and more specifically, to a method and device for determining specific parameters of a liquid cell sample by differential digital holographic microscopy. The method offers a non-destructive manner of analysing cells and can be used for the diagnosis of various diseases. By use of a differential digital holographic microscope, a set of data linked to the cell sample is obtained and is compared to a reference database of cellular parameters. The present invention furthermore discloses a sample vial, to be used in a system that employs the sample analysing method by differential digital holographic microscopy of the invention.

### BACKGROUND

The diagnosis of various diseases, in particular cancer, requires often the analysis of a cell sample, to evaluate whether abnormal or aberrant cells are present in the sample. Mainly, a pathologist or other skilled medical personnel will base the diagnosis on specific characteristics of the cells in the sample, such as cell morphology, the presence of certain types of cells or proteins and more. These cytological tests mostly require the fixation of cells on a substratum and the use dyes or stainings, to visualize specific features of the cells. As many of the solutions used to fix and stain the cells, this approach will inevitably lead to loss of cell structures and information stored therein. This might thus interfere with the possibility of a reliable interpretation and diagnosis from the sample. Inadequate processing of a sample may lead to an increased number of false negatives diagnoses. For instance, of the over 50 million cervical cytological PAP smears, which are performed in the USA each year, a high false-negative interpretation rate of 20-40% has been described (Williams et al., 1998), frequently leading to fatal consequences. Most of these false negatives are the result of inadequate sample processing.

Therefore, there is need in diagnosis for a method and device that analyses cell samples in a non-destructive, non-detrimental way, or at least provides information of the status of the sample and the cells present prior to its further processing. This will undeniably lead to a more reliable diagnosis method as more accurate information will be obtained from the analyzing sample.

Digital imaging and processing of samples has gained ground in the past years as a new and better way of analyzing cellular samples in pathology. Digital holographic microscopy enables the study of living cells without the need for markers or dyes, and enables quantification of the studied objects. The possibilities of digital holographic microscopy (DHM) have increased during the last years due to an increase in the development of digital sensors and computers. Unlike conventional microscopes, such as phase contrast microscope or a confocal microscope, both phase contrast and amplitude contrast images may be recorded simultaneous in the DH microscope. This means that two images of the object can be recorded in the same hologram, one of these images with an amplitude contrast and the other with a phase contrast. These images can subsequently be analyzed either separately or combined. Their information content may be used to build a computerized three-dimensional image of the object.

US20100060897 discloses a method and device for non-destructive analysis and characterization of a cell sample. The invention makes use of a digital holographic microscope for analyzing certain parameters of a cell (such as volume, size, refractive index) and to determine the number of cells in the sample.

WO2009154558 discloses an observation vessel for digital holographic microscopy, which contains the transparent biological object to be analyzed. The vessel is designed to assure an optimal quality of the hologram.

The prior art DHM systems described here above all require the sample to be placed within the interferometer, in order to obtain a qualitative image, i.e. the sample is placed behind the first beam splitter, in the object beam, but before the optical element (e.g. a second beam splitter) which superposes the object beam with the reference beam in order to create an interferometric image. In a system where a plethora of samples need to be analyzed in a rather short amount of time, this means a disadvantage. Furthermore, the consecutive loading and unloading of the system's interferometer with sample vials may cause a disruption of alignment of the various components (e.g. beam splitters, mirrors, optical elements, etc.) of the interferometer. Slight differences in alignment can already be sufficient to lower the quality of the data and images obtained by the system and may make a direct comparison between samples in different vials troublesome. Therefore, there remains a need in the art for a DHM system in which the fast and preferably automated replacement of samples does not lead to a degradation of the quality of the DHM results. One way of solving this problem, would be to fixate all optical components such that they are unable to move during the replacement of the sample. The set-up described in US20100060897 seems to disclose a way of fixating the interferometric components. Nevertheless, the latter set-up is still not suitable for the fast and automated replacement needed for the analysis of a large number of sample, in particular, the table shown in the figures of US20100060897 onto which a sample can be placed is fixed to the interferometer, which means that fast and automated replacement of a sample could lead to undesired shocks to and accompanying disruptions of the DHM system.

The present invention aims to improve on the prior art DHM system, by using a system in which the sample is not introduced in between the interferometric components of the DHM system. In this case, the problem of disrupting the interferometer by the fast and automated replacement does not pose itself.

Furthermore, the abovementioned prior art DHM systems make use of laser light as illumination means. Laser light is highly coherent, both spatially and temporally. In fact, laser light is generally called ‘better’ when its coherence length and time is larger. However, a laser is usually an expensive component and laser light is not an absolute requirement for producing holographic images. This is definitely the case for the He—Ne laser used in the set-up which is disclosed in US20100060897. A He—Ne laser is known for producing highly coherent light with a wavelength which is fixed around 633 nm and which is still at least about 15 cm in size.

Therefore, in a preferred embodiment, the present invention aims to use illumination means which produces spatially and temporally partially coherent light and which is much cheaper, such as a LED. A LED produces light with a spectrum centered around a known wavelength, which is spatially and temporally partially coherent, i.e. not as coherent as laser light, but still coherent enough to produce holographic images of the quality which is necessary for the applications at hand. LEDs also have the advantage of being available for many different wavelengths and are very small in size and easy to use or replace if necessary.

EP1524491 discloses an apparatus and a process for the visualisation of a sample, said apparatus comprising as elements at least:

(i) a sample cell able to contain a sample to be studied;

(ii) an illumination source for illuminating said sample and creating thereby an incident sample beam;

(iii) a microscope coupled to an interferometer for generating an interference pattern from said incident sample beam by splitting said beam into a first output beam and a second output beam following two different optical paths in the interferometer and by recombining said output beams;

(iv) imaging means for detecting said interference pattern,

said apparatus being characterised in that the apparatus further comprises optical tilting means located in one of the optical paths of the interferometer so as to create a tilt between the first output beam and the second output beam said tilt resulting into a shift between the first output beam and the second output beam on the imaging means, and the relative arrangement of said optical tilting means and the other elements of the apparatus being such as to obtain a differential interference pattern on said imaging means.

Kemper et al., “Simplified approach for quantitative digital holographic phase contrast imaging of living cells” (Journal of Biomedical Optics 16(2), 026014, February 2011) discloses a Michelson interferometer approach for digital holographic microscopy that avoids a separately generated reference wave by superposition of different image areas. It was shown that this simplified arrangement yields improved phase stability. Furthermore, results from time-lapse investigations on living pancreas tumor cells demonstrate the capability of the method for reliable quantitative phase contrast imaging.

Dan Fu et al., “Quantitative DIC microscopy using an off-axis self-interference approach” (Optics Letters, OSA, Optical Society of America, Vol. 35, no. 14, 15 Jul. 2010, pages 2370-2372) discloses a quantitative DIC microscopy method based on off-axis sample self-interference. The digital holography algorithm is applied to obtain quantitative phase gradients in orthogonal directions, which leads to a quantitative phase image through a spiral integration of the phase gradients. This method is practically simple to implement on any standard microscope without stringent requirements on polarization optics. Optical sectioning can be obtained through enlarged illumination.

EP1631788 describes a digital holographic microscope whereby an object to be analyzed can be placed outside the interferometer. More specifically, it discloses an improved digital holographic microscope and a process for obtaining with low temporal distortion high quality three-dimensional images of samples including fluorescence samples and thick samples. It provides for an apparatus and a process adapted to low noise three-dimensional imaging of strong optical phase distorted samples and which is easy to use, namely with reduced technical adjustments comparatively to the apparatus and processes of the prior art. Therefore, it provides an alternative to the other prior art DHM systems. In the following, the technique disclosed in EP1631788 will be called differential digital holographic microscopy or DDHM.

However, also EP1631788 does not disclose a set-up which is suitable for the fast and automated analysis of samples. More specifically, EP1631788 does not disclose how a sample should be prepared for analysis, and a positioning stage is needed before a sample can be analyzed. The samples which can be used in the DHM set-up and method as disclosed in EP1631788 are thick living biological samples, thick transparent samples and fluorescent samples, but the preparation of such samples typically need the intervention of a trained human operator and/or the preparation is time consuming. The positioning stage in EP1631788 is necessary to position the part of the sample from which a hologram has to be taken, in the focal plane of an objective lens. It is not disclosed elaborately how this positioning is done exactly, but from the drawings and text, one may infer that positioning is done by placing the sample on top of a sample holder or table which is supported by a system comprising (electro-)motors to adapt the table's position. It should be clear that a positioning stage may be time-consuming and is therefore undesired when a large number of samples is to be analyzed.

The present invention aims to improve on the DHM method and system of EP1631788 by using liquid cell samples, thereby solving the problem of possibly time-consuming preparation, and by using a sample vial of known dimensions, thereby solving the problem of a time-consuming positioning stage, since the sample vial may be easily positioned in a sample vial holder which can automatically be positioned such that the liquid cell sample in the sample vial is placed in the illumination beam of the illumination means of the DHM set-up. Furthermore, since the aim of the present invention is to obtain data about a sample which in a preferred embodiment do not concern details about the absolute or relative position of the cells in the sample, but rather averages over the whole liquid cell sample, the positioning stage is not crucial for the analysis method, i.e. as long as the sample vial is placed such that the focal plane of the objective lens of the DHM set-up lies in the vial, the sample can be assumed to be well placed.

Because of the reasons mentioned above, there remains a need in the art for an improved, non-destructive system for cytological screening and diagnosis, which is preferably suited for the fast, correct and automated analysis of a large number of samples. The present invention aims to provide a solution to at least some of the problems present mentioned above.

### SUMMARY OF THE INVENTION

The present invention provides for a method for analyzing liquid cell samples, in a non-destructive, non-invasive manner and to provide information on the cells present in the sample. In the current invention, a cell sample will be analyzed by a differential digital holographic microscope (DDHM) and the practitioner or pathologist will be provided with a digital report with certain parameters of the sample and their comparison to a reference database, as well as with a digital image of the sample, prior to handling the sample. This will give the practitioner or pathologist the chance to evaluate the raw sample in an unbiased manner, by taking the provided cell sample parameters into account, as well as the image made thereof. Diagnosis can be solely based on the parameters provided by the system, or if desirable, the practitioner or pathologist can proceed by more conventional means of diagnosing. The present invention also discloses a sample vial, to be used in conjunction with the method described above. The sample vial may contain a label for recognition and identification of the sample. In a preferred embodiment, the system will contain means to identify the label on the sample, and correlate it with the data obtained by the DDHM. This way, a one-to-one correlation is provided between the sample and the report containing the data.

Digital holographic microscopy enables the study of living cells without the need for markers or dyes, and enables quantification of the studied objects. The possibilities of digital holographic microscopy (DHM) have increased during the last years due to an increase in the development of digital sensors and computers. The method visualizes cells without any staining up to a degree of cellular and compartment distinguishability which allows to efficiently segment the cells, count their number and reliably classify them according to their histological provenience.

In a first aspect, the present invention provides a method for analyzing a liquid cell sample, comprising the steps of:

a) providing at least one liquid cell sample in a sample vial;

b) obtaining data linked to the cells in the sample by performing differential digital holographic microscopy on said liquid cell sample in said sample vial.

Using a liquid cell sample will ensure an easy, fast and possibly automated preparation of the sample for analysis. Furthermore, since the cells are easily uniformly distributed over the complete sample e.g. by shaking the sample vial with the liquid cell sample, there is no need to scan the sample over the whole thickness and a subsequent computational procedure for obtaining data of the cells' characteristics as averaged over the whole sample. In fact, the averaging of the cells' properties can be ensured by the uniform distribution of the cells over the complete liquid cell sample, whereby only a small part of the sample needs to be analysed. Thusly, no time-consuming repositioning of the sample is needed to obtain holographic images over the whole thickness of the sample. Furthermore, using DDHM to perform the analysis allows a rapid, efficient and possibly automated replacement of the sample, since the sample is not introduced in between the interferometric components of the DHM system. In this case, the problem of disrupting the interferometer by the fast and automated replacement does not pose itself. In a preferred embodiment, the step b) of the method for analyzing a liquid cell sample comprises the step of

c) illuminating in transmission and/or in reflection with illumination means said liquid cell sample and producing thereby a sample beam, whereby said illumination means preferably comprise spatially and temporally partially coherent light.

It is obvious that to take a holographic image, one needs to provide illumination means. However, in the present embodiment, the light from these illumination means may comprise spatially and temporally partially coherent light, in contrast with prior art DHM methods, which only provided highly correlated laser light. Spatially and temporally partially coherent light can be produced by e.g. a LED. A LED is cheaper than a laser and produces light with a spectrum centered around a known wavelength, which is spatially and temporally partially coherent, i.e. not as coherent as laser light, but still coherent enough to produce holographic images of the quality which is necessary for the applications at hand. LEDs also have the advantage of being available for many different wavelengths and are very small in size and easy to use or replace if necessary. Therefore, providing a method which can use spatially and temporally partially coherent light for obtaining holographic images will lead to more cost-effective devices for implementing such a method.

It should be noted that differential digital holographic microscopy in the present method may be performed by a differential digital holographic microscope which comprises a differential interferometer, and preferably also illumination means and a digital recording device connected to a processing device such as a computer. The differential DHM may use a spatial or temporal phase-shifting technique for acquiring holographic data of the sample. Preferably a spatial phase-shifting technique is used. In a preferred embodiment, the method comprises the step of obtaining the data by at least approximately computing a phase gradient (or spatial derivative of a phase) of interfering output beams of said interferometer.

In a more preferred embodiment, the step b) of the method for analyzing a liquid cell sample comprises the steps of
d) generating by means of the differential interferometer interfering beams from said sample beam;
e) adequately positioning and orientating the tilting means in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device;
f) detecting and recording the fringe interference image thus formed by the interfering beams on the sensor of the imaging device;
g) sending the interference image to processing means, such as a computer;
h) possibly acquiring other similar but different interference images following steps c-g from said sample by implementation of the phase-stepping method;
i) processing said interference image(s) so as to extract the optical amplitude and/or phase of the sample by implementation of the phase stepping method or the Fourier transform data processing; and
j) computing said data linked to the cells in the sample from said optical amplitude and/or phase of said liquid cell sample.

In a preferred embodiment, the method for analyzing a liquid cell sample comprises the steps of
k) providing at least once a test sample in a test sample vial;
l) illuminating in transmission and/or in reflection with illumination means said test sample and producing thereby a test sample beam, whereby said illumination means preferably comprise spatially and temporally partially coherent light;
m) generating by means of the differential interferometer interfering beams from said test sample beam;
n) adequately positioning and orientating the movable part of the interferometer so as to equalize the optical length of said interfering beams with an accuracy in the range of less than the maximum wavelength of the illumination means to a few maximum wavelengths by means of the moving means.

These steps provide a way of calibrating the system for analyzing a liquid cell sample, and can be performed multiple times, i.e. calibration can be done whenever it is deemed necessary.

In a preferred embodiment, the biological sample is a tissue sample, a biopsy sample, a brushing or scraping sample from oral cavities, nipple secretions, skin lesions, and eye brushings, a fine-needle-aspiration sample, a smear sample, a mucoid specimens taken from respiratory and gastrointestinal tracts and body fluids such as serous effusions or urinary or cerebrospinal fluids. In another preferred embodiment, the said smear sample is a cervical smear sample.

A problem in prior art techniques and systems using differential DHM, is the difficulty in preparing samples, especially since most DHM and differential DHM techniques are used in research labs for imaging living cells and not for diagnostic purposes, whereby speedy, easy and error-free or at least error-poor preparing of samples is an issue, as well as transporting and/or storing the samples. The present invention thereto provides a method for analyzing a liquid cell sample, whereby cells in the sample are suspended in a solution when they are to be analysed by differential DHM. In particular in diagnostics applications, preparing a liquid cell sample whereby the cells are suspended in a solution is much easier and faster than preparing a liquid cell sample on a substrate, in a Petri dish or on a slide, and makes it easier to transport the sample. For certain diagnostics, it is further advantageous to ensure the presence of single cells in the sample, e.g. for cell-specific analyses or for cell counting.

Therefore, in a preferred embodiment, cells in said liquid cell sample are suspended in a solution whereby said solution comprises an anti-clumping agent. The anti-clumping agent ensures that at least some cells are single cells, i.e. freely suspended cells which are not adhering to other cells or to surfaces of the sample vial. In a more preferred embodiment, at least 20%, more preferably at least 30%, even more preferably at least 40%, yet more preferably at least 50%, still more preferably at least 60%, yet even more preferably at least 70%, still even more preferably at least 80%, most preferably at least 90% of the cells in said liquid cell sample are single cells. Such percentages may be reached by providing a sufficient amount of anti-clumping agent, or by careful choosing of the anti-clumping agent, preferably from the list of: EDTA, EGTA, β-mercapto-ethanol, BSA, trypsin, any other commercially available anti-clumping agents, or any combination thereof. The percentage of single cells in solution may be obtained by making use of conventional cell counting techniques, for instance by using a counting chamber, e.g. a Bürker-Türk cell chamber or a Neubauer hemocytometer. Alternatively, said percentage single cells can be measured by DHM.

In a preferred embodiment, the method comprises the step of shaking said sample, preferably prior to and/or during the step of obtaining said data by performing differential digital holographic microscopy. Shaking the sample may increase the number of single cells in the sample.

Another advantage of the present method, is that the cells in suspension can be observed by the differential DHM, even if the sample is thick, i.e. even when the distance which the illumination beam of the differential DHM travels across the sample is relatively large, more than 1 mm. Therefore, in an embodiment, the differential DHM comprises illumination means comprising an illumination beam, whereby the distance which said beam travels through the liquid cell sample, is larger than the height of 1 cell, e.g. larger 30 micron, preferably larger than 100 micron, more preferably larger than 1 mm, even more preferably larger than 3 mm, yet more preferably larger than 5 mm, still more preferably larger than 7 mm, yet even more preferably larger than 10 mm, yet still more preferably larger than 15 mm, still even more preferably larger than 20 mm.

In a preferred embodiment, cells in said sample are fixated, e.g. for diagnostic purposes. Therefore, in an embodiment, said solution of said liquid cell sample comprises a fixation agent, e.g. alcohol such as ethanol, methanol, or aldehydes such as paraformaldehyde (toxisch), formaldehyde, glutaraldehyde, or any combination thereof.

In another preferred embodiment, the sample is collected and preserved in a sample vial, comprising a preservative solution for the cells. This solution may comprise a buffer component, an alcohol, such as ethanol, and an anti-clumping agent, such as EDTA. In a preferred embodiment, the sample vial comprises a material which is transparent for the illumination beam of said illumination means. In this way, the illumination and sample beams are not unnecessarily attenuated by the vial's walls. In another preferred embodiment, the sample vial comprises a material which is only transparent for illumination beams with a wavelength centered around the wavelength of the illumination means. In the latter case, the possibly malicious effects of light of other wavelengths during the transport and analysis of the sample vial with the liquid cell sample are opposed.

In one embodiment, the sample vial is a cylinder. In another embodiment, the sample vial is a cuboid. In still another embodiment, the sample vial is of frusto-conical shape. In still another embodiment, two parts of the sample vial's walls comprise essentially flat transparent surfaces, in between which a representative part of the sample can be placed. In a preferred embodiment, these parts are located on the bottom of the sample vial and on the cap. In another preferred embodiment, these parts are located on the sample vial's upstanding walls. In a more preferred embodiment, the sample vial is a cylinder with two essentially flat and parallel parts opposite one another integrated in the upstanding wall of the sample vial.

In another aspect, the present invention provides for a method and means to maintain a one-to-one correlation between the sample vials and the produce therefrom. When a cell sample is collected from a patient and deposited in the preservative fluid in the sample vial, creating cellular particles in a liquid suspension, the vial may be marked with unique identifying indicia corresponding to the type of sample, patient, date obtained, etc.

The said identifying indicia preferably comprises fixed indicia and programmable indicia. In one embodiment, the fixed identifying indicia is a bar code. In another embodiment, the programmable indicia comprises a RFID tag.

When the sample vial is loaded into the system, the indicia corresponding to the sample are identified. In the case of a bar code, a laser bar code scanner can be used. In case of an RFID tag, a RFID reader may be used.

In a preferred embodiment, derivatives of the sample, such as digital data, reports, images, are marked with indicia that correspond to the sample indicia.

In one embodiment, an agitating, stirring or ultrasonic device prepares the sample for collection such as, for example, by agitating the sample in a manner so as to create a generally uniform dispersion of particles of interest throughout the sample.

In a preferred embodiment, the obtained data from the liquid cell sample comprise cell density, cell morphology, cell size, the ratio between nucleus and cytoplasm of a cell and/or the optical density of a cell present in the said liquid cell sample.

In a further aspect, the system includes a microscope able to work in digital holography for obtaining 3D images of a sample, said microscope comprising as elements at least: (i) illumination means for illuminating in transmission and/or in reflection a sample and producing thereby a sample beam, said illumination means being characterized by a given spectral width having a maximum illumination wavelength, said illumination means being selected from the group consisting of temporally coherent and spatially partially coherent illumination means, temporally and spatially partially coherent illumination means, and fluorescence excitation sources; (ii) imaging means comprising a microscope objective having a front focal plane, and focusing means having a back focal plane; (iii) an interferometer for generating interfering beams from the sample beam, said interferometer being located behind the microscope objective and in front of the focusing means, and comprising a first interferometer arm and a second interferometer arm, the focusing means having one front focal plane in each of said first and second interferometer arms, said first interferometer arm comprising a first beam splitter, a first reflecting element and a second beam splitter, said second interferometer arm comprising the first beam splitter, a second reflecting element and the second beam splitter, wherein some of said reflecting elements and beam splitters are mounted on moving means so as to equalize the optical length of the interfering beams with an accuracy in the range of less than the maximum wavelength of the illumination means to a few maximum wavelengths; (iv) an electronic or digital imaging device provided with a sensor which is located in the back focal plane of the focusing means, for detecting and recording the fringe interference images formed thereon by the interfering beams; (v) processing means, such as a computer, conceived for at least processing said fringe interference images by digital holography techniques; said microscope being characterized in that said it further comprises: (vi) tilting means located in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device.

In a preferred embodiment, a holographic image is obtained by a differential digital holographic microscope. In further preferred embodiment of the present invention certain cell parameters such as, but not limited to the size of a cell, the morphology of a cell, the number of cells or cell density, the ratio between cytoplasm and nucleus of a cell and/or the optical density of the nucleus of a cell present on holographic image as mentioned herein above are established with means for image and/or form recognition. Said means for image and/or form recognition is preferably configured to determine a value indicative of the size of a cell, the morphology of a cell, the number of cells, the ratio between cytoplasm and nucleus of a cell and/or the optical density of the nucleus of a cell.

In a further preferred embodiment of the present invention the means for image and/or form recognition as mentioned herein above is a picture and/or form recognition data processor, a picture and/or form recognition software or a picture and/or form recognition program. In another preferred embodiment, the cell parameters as mentioned here above are provided to the practitioner in the format of a report linked to a certain sample. In still another preferred embodiment, a digital report and image of the liquid cell sample is created based upon the data obtained by digital holographic microscopy and the correlation of the data with a reference database of known cellular parameters.

In another embodiment of the present invention the parameters obtained by DHM are compared with a reference database. In a preferred embodiment of the present invention said reference database is the British Society for Clinical Cytology (BSCC) look-up table or the Bethesda System database (Bethesda system for reporting cervical/vaginal cytological diagnoses, 1993, Acta Cytol. 37, 115).

To improve the fast, reliable, accurate and automated analysis of a large number of liquid cell samples, in a preferred embodiment step a) of the method for analyzing a liquid cell sample comprises the steps of
o) placing at least one sample vial with a liquid cell sample in a movable sample vial holder;
p) positioning said sample vial holder with said sample vial such that said liquid cell sample can be illuminated by said illumination means.

It should be clear that such steps improve the speed at which a liquid cell sample in a sample vial can be positioned correctly for subsequent analysis. Furthermore, a sample vial is more easily replaced by the next sample vial when the sample vial is first placed in a sample vial holder, and only then positioned, preferably in an automated way, for analysis.

In a further aspect, the present invention provides a system for analyzing a liquid cell sample, comprising
(i) a differential digital holographic microscope comprising illumination means, a differential interferometer and a digital recording device connected to a processing device such as a computer;
(ii) at least one exchangeable sample vial comprising a liquid cell sample;
(iii) at least one movable sample vial holder; characterized in that
(iv) said sample vial holder is adapted to receive said sample vial;
(v) said sample vial holder is adapted to position said sample vial in the illumination beam of said illumination means of said differential digital holographic microscope.

Such a system is ideally suited for analyzing a large number of liquid cell samples in a fast, reliable, accurate and very complete way. The liquid cell samples are stored in sample vials, which have known dimensions such that they easily fit in the movable sample vial holder. The thickness of the sample vials is also determined such that the front focal plane of the differential digital holographic microscope automatically falls within the liquid cell sample, without the needs of refocusing the microscope for each sample. The sample vial holder can then be moved, e.g. rotated or translated, to position the sample vial with the liquid cell sample essentially in the front focal plane of the objective lens of the differential interferometer. After taking the necessary holographic images, the sample vial holder with sample vial may be moved away. At the same time, or subsequently another sample vial in the same or another sample vial holder may be moved to position the sample vial with the liquid cell sample essentially in the front focal plane of the objective lens of the differential interferometer.

In a preferred embodiment, cells in said sample are suspended in a solution whereby said solution comprises an anti-clumping agent. This increases the probability that there is one or more cells in the field of view, in or near a focusing plane of the microscope and/or in the illumination beam of the microscope, making it easier to perform diagnostics analyses at a high rate, as the positioning of the sample or the preparation of the sample is less crucial for obtaining the data.

In a preferred embodiment, the system for analyzing a liquid cell sample comprises a sample vial comprises a material which is transparent for the illumination beam of said illumination means. In a preferred embodiment, the system for analyzing a liquid cell sample comprises a sample vial which has identifying indicia, preferably fixed indicia or programmable indicia.

In a preferred embodiment, the system for analyzing a liquid cell sample comprises a data processing unit, a computer or an electronic device which is capable of performing an algorithm to compare said data obtained by said differential digital holographic microscope with a reference database of cellular parameters.

In a more preferred embodiment, the system for analyzing a liquid cell sample comprises a computer or printer capable of providing a report based on the comparison of said data and said reference database, whereby said report is correlated with said indicia on said sample vial.

### DETAILED DESCRIPTION OF THE INVENTION

The present invention provides for a method and device for analyzing liquid cell samples, in a non-destructive, non-invasive manner and to provide information on the cells present in the sample. In the current invention, a cell sample will be analyzed by a differential digital holographic microscope (DDHM) and the practitioner or pathologist will be provided with a digital report with certain parameters of the sample and their comparison to a reference database, as well as with a digital image of the sample, prior to handling the sample. This will give the practitioner or pathologist the chance to evaluate the raw sample in an unbiased manner, by taking the provided cell sample parameters into account, as well as the image made thereof. Diagnosis can be solely based on the parameters provided by the system, or if desirable, the practitioner or pathologist can proceed by more conventional means of diagnosing. The present invention also discloses a sample vial, to be used in conjunction with the method described above. The sample vial contains a label for recognition and identification of the sample. The system will contain means to identify the label on the sample, and correlate it with the data obtained by the DDHM. This way, a one-to-one correlation is provided between the sample and the report containing the data.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The term “biological sample” or “sample” as used herein refers to any specimen obtained from a biological organism, preferably a living organism. The term relates also to specimen obtained from non-living, i.e. dead biological organisms, in particular recently deceased organisms. The term “biological organism” includes in general eukaryotic systems and may also comprise sub-portions of eukaryotic systems. In particular, such organisms include higher eukaryotes. In preferred embodiments of the present invention a biological sample may be derived from an animal, preferably from a mammal, e.g. from a cat, a dog, a swine, a horse, a cattle, a sheep, a goat, a rabbit, a rat, a mouse, a monkey. Particularly preferred is a sample obtained from a human being.

In one embodiment the biological sample is a tissue sample, a biopsy sample, a brushing or scraping sample from oral cavities, nipple secretions, skin lesions, and eye brushings, a fine-needle-aspiration sample, a smear sample, a mucoid specimens taken from respiratory and gastrointestinal tracts and body fluids such as serous effusions or urinary or cerebrospinal fluids.

In a preferred embodiment, said sample is a smear sample.

In another preferred embodiment, said smear sample is a cervical sample.

The term “morphology of a cell” as used herein refers in general to the form, structure and configuration of a cell and may include aspects of the cell appearance like shape, color or pattern of internal or external part of a cell. The term “form of a cell” as used herein refers to typical cell forms like circular cells, elliptic cells, shmoo like cells, division forms like dumbbells, star-like cell forms, flat cells, scale-like cells, columnar cells, invaginated cells, cells with concavely formed walls, cells with convexly formed walls, the presence of prolongations, appendices or cilia, the presence of angles or corner etc. Typical morphologies or forms would be known to the person skilled in the art and can be derived from Junqueira et al., 2002, Basic Histology, Mcgraw-Hill editors.

The “size of a cell” as used herein may be determined in relation to a calibration mark, in relation to the size of neighboring cells, the size of all cells present on a given image or the size of cells derivable from a suitable histological database comprising data of cell sizes. Preferably, the size of a cell may be calculated in relation to a defined or established area of the image, e.g. an area comprising about 100, 200, 300, 400, 500, 600, 700, 800, 900, 1000, 2000, 4000, 6000, 8000, 10000, 15000, 20000, 25000, 30000, 35000, 38000, 40000, 43000, 45000, 50000, 60000 or 70000 μm². The determination of the size of a cell also encompasses in a specific embodiment the determination of the ratio between the surface area and the volume of a cell.

The “number of cells” as used herein may be determined in relation to a defined or established area of the image, e.g. an area comprising about 100, 200, 300, 400, 500, 600, 700, 800, 900, 1000, 2000, 4000, 6000, 8000, 10000, 15000, 20000, 25000, 30000, 35000, 38000, 40000, 43000, 45000, 50000, 60000 or 70000 μm². The determination of the number of cells may also encompass the determination of the number of cells in one cell layer, e.g. if tissues comprising more than one cell layer are analyzed. Alternatively, the number of cells in all cell layers may be determined. In such a case the number of cells per cell or tissue layer may be determined by additionally determining the number of cell layers present in the object to be analyzed, i.e. the biological sample.

The term “ratio between cytoplasm and nucleus of a cell” as used herein refers to a comparison of the area of cytoplasm and the area of nuclei present in said cytoplasm of an UV radiation reaction image according to the present invention.

The area of cytoplasm may or may not comprise cell well areas or internal cell structures like vacuoles, mitochondrial etc. The area of nuclei may or may not comprise nuclear membrane districts. In case more than one nucleus should be present in a cell, either the area of one nucleus may be determined or the area of all nuclei present may be determined. The ratio of cytoplasm and nucleus of a cell may be determined for each cell individually or for any grouping or sub-grouping of cells present in a defined area of the image, e.g. an area comprising about 100, 200, 300, 400, 500, 600, 700, 800, 900, 1000, 2000, 4000, 6000, 8000, 10000, 15000, 20000, 25000, 30000, 35000, 38000, 40000, 43000, 45000, 50000, 60000 or 70000 μm².

The term “optical density” as used herein refers to the measure of the transmittance of an optical element for a given length at a given wavelength [lambda], preferably according to the formula:

OD_{λ}=log₁₀O=−log₁₀T=−log₁₀(I/I₀)

wherein
O=the per-unit opacity
T=the per-unit transmittance
IO=the intensity of the incident beam of electromagnetic radiation
I=the intensity of the transmitted beam of electromagnetic radiation

In a specific embodiment, the optical density of a nucleus of a cell in comparison to the optical density of a nucleus of a second cell may be determined.

Furthermore, the optical density of a nucleus of a cell in comparison to the optical density of the cytoplasm of a cell or vice versa may be determined. Furthermore, the optical density of all nuclei in a defined area of the image and/or of all cytoplasmic regions in a defined area of the image may be determined.

In a preferred embodiment, the sample is collected and preserved in a sample vial, comprising a preservative solution for the cells.

In a preferred embodiment, the said sample vial comprises a material which is transparent for the illumination beam of said illumination means, as does the lid used to close the sample vial.

In one embodiment, the sample vial is a cylinder. In another embodiment, the sample vial is a cuboid. In still another embodiment, the sample vial has a frusto-conical shape. In yet another embodiment, the sample vial has different sections, each section having a different shape as previously disclosed. In still another embodiment, one or more parts of the sample vial's walls comprise an essentially flat transparent surface, through which a beam of light can traverse without refraction. In a preferred embodiment, these one or more parts are located on the bottom of the sample vial and on the cap. In another preferred embodiment, these one or more parts are located on the sample vial's upstanding walls. In a more preferred embodiment, the sample vial is a cylinder with two essentially flat and parallel parts opposite one another integrated in the upstanding wall of the sample vial.

In one embodiment of present invention, the sample within the said sample vial is analyzed by Digital Holographic Microscopy (DHM).

Digital Holographic Microscopy (DHM) is a technique which allows a recording of a 3D sample or object without the need of scanning the sample layer-by-layer. In this respect DHM is a superior technique to confocal microscopy. In DHM, a holographic representation is recorded by a digital camera such as a CCD- or a CMOS-camera, which can subsequently be stored or processed on a computer.

To make a holographic representation, or hologram, traditionally a highly coherent light source such as laser-light, is used to illuminate the sample. In the most basic set-up, the light form the source is split into two beams, an object beam and a reference beam. The object beam is sent via an optical system to the sample and interacts with it, thereby altering the phase and amplitude of the light depending on the object's optical properties and 3D shape. The object beam which has been reflected on or transmitted through the sample, is then made (e.g. by set of mirrors and/or beam splitters) to interfere with the reference beam, resulting in an interference pattern which is digitally recorded. Since the hologram is more accurate when object beam and reference beam have comparable amplitude, an absorptive element can be introduced in the reference beam which decreases its amplitude to the level of the object beam, but does not alter the phase of the reference beam or at most changes the phase globally, i.e. not dependent on where and how the reference beam passes through the absorptive element. The recorded interference pattern contains information on the phase and amplitude changes which depend on the object's optical properties and 3D shape.

An alternative way of making a hologram is by using the in-line holographic technique. In-line DHM is similar to the more traditional DHM, but does not split the beam, at least not by a beam splitter or other external optical element. In-line DHM is most preferably used to look at a not-too-dense solution of particles, e.g. cells, in a fluid. Thereby some part of the at least partially coherent light will pass through the sample without interacting with the particles (reference beam) and interfere with light that has interacted with the particles (object beam), giving rise to an interference pattern which is recorded digitally and processed. In-line DHM is used in transmission mode, it needs light with a relatively large coherence length, and cannot be used if the samples are too thick or dense.

Another DHM technique called differential DHM (DDHM) is disclosed in European patent EP 1 631 788. DDHM is different to the other techniques in that it does not really make use of reference and object beams. In a preferred set-up of DDHM, the sample is illuminated by illumination means which consist of at least partially coherent light in reflection or in transmission mode. The reflected or transmitted sample beam can be sent through an objective lens and subsequently split in two by a beam splitter and sent along different paths in a differential interferometer, e.g. of the Michelson or Mach-Zehnder type. In one of the paths, a beam-bending element or tilting means is inserted, e.g. a transparent wedge. The two beams are then made to interfere with each other in the focal plane of a focusing lens and the interference pattern in this focal plane is recorded digitally and stored by e.g. a CCD-camera connected to a computer. Hereby, due to the beam-bending element, the two beams are slightly shifted in a controlled way and the interference pattern depends on the amount of shifting. Then the beam-bending element is turned, thereby altering the amount of shifting. The new interference pattern is also recorded. This can be done a number N of times, and from these N interference patterns, the gradient (or spatial derivative) of the phase in the focal plane of the focusing lens can be approximately computed. This is called the phase-stepping method, but other methods of obtaining the phase gradient are also known, such as a Fourier transform data processing technique. The gradient of the phase can be integrated to give the phase as a function of position. The amplitude of the light as a function of position can be computed from the possibly but not necessarily weighted average of the amplitudes of the N recorded interference patterns. Since phase and amplitude are thus known, the same information is obtained as in a direct holographic method (using a reference and an object beam), and a subsequent 3D reconstruction of the object can be performed.

In the most preferred embodiment, the digital holographic microscope used in the system is of the type of the differential digital holographic microscope (DDHM) as outlined above. The said microscope comprises as elements: (i) illumination means for illuminating in transmission and/or in reflection a sample and producing thereby a sample beam, said illumination means being characterized by a given spectral width having a maximum illumination wavelength, said illumination means being selected from the group consisting of temporally coherent and spatially partially coherent illumination means, temporally and spatially partially coherent illumination means, and fluorescence excitation sources; (ii) imaging means comprising a microscope objective having a front focal plane, and focusing means having a back focal plane; (iii) an interferometer for generating interfering beams from the sample beam, said interferometer being located behind the microscope objective and in front of the focusing means, and comprising a first interferometer arm and a second interferometer arm, the focusing means having one front focal plane in each of said first and second interferometer arms, said first interferometer arm comprising a first beam splitter a first reflecting element and a second beam splitter, said second interferometer arm comprising the first beam splitter, a second reflecting element and the second beam splitter, wherein some of said reflecting elements and beam splitters are mounted on moving means so as to equalize the optical length of the interfering beams with an accuracy in the range of less than the maximum wavelength of the illumination means to a few maximum wavelengths; (iv) an electronic or digital imaging device provided with a sensor which is located in the back focal plane of the focusing means, for detecting and recording the fringe interference images formed thereon by the interfering beams; (v) processing means, such as a computer, conceived for at least processing said fringe interference images by digital holography techniques; said microscope being characterized in that said it further comprises: (vi) tilting means located in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device.

The liquid cell sample in the sample vial can be positioned outside the interferometer in front of the microscope essentially in the front focal plane of the microscope objective. Tilting means are located in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device.

A process for obtaining images, preferentially 3D images using the differential digital holographic microscope as outlined above comprises following steps:

providing the illumination means, the imaging means including an objective and focusing means, the differential interferometer, the imaging device and the processing means, the positioning stage, and the tilting means;

placing the positioning stage outside the interferometer in the front focal plane of the microscope objective;—positioning the imaging device so that its sensor is placed in the back focal plane of the focusing means;

positioning the interferometer between the objective and the focusing means;

placing at least some of the reflecting elements and the beam splitters of the interferometer on moving means so as to form a movable part;

performing position and orientation pre-adjustments of the microscope by addition of a test sample, by: (i) placing the test sample; (ii) illuminating in transmission and/or in reflection with the illumination means said test sample and producing thereby a test sample beam; (iii) generating by means of the interferometer interfering beams from said test sample beam; (iv) adequately positioning and orientating the movable part of the interferometer so as to equalize the optical length of said interfering beams with an accuracy in the range of less than the maximum wavelength of the illumination means to a few maximum wavelengths by means of the moving means; (v) adequately positioning and orientating the tilting means in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device; (vi) detecting and recording the fringe interference image thus formed by the interfering beams on the sensor of the imaging device;

once the microscope has been thus pre-adjusted, replacing the test sample by a biological sample to be studied and illuminating said sample so as to obtain an interference image as disclosed in (i) to (vi);

recording said interference image;

possibly acquiring other similar interference images from said sample by implementation of the phase-stepping method;

processing said interference image (s) so as extract the optical amplitude and phase of the sample by implementation of the phase stepping method or the Fourier transform data processing.

The present invention provides a method for analyzing a liquid cell sample, comprising the steps of:

a) providing at least one liquid cell sample in a sample vial;

b) obtaining data linked to the cells in the sample by performing differential digital holographic microscopy on said liquid cell sample in said sample vial.

Using a liquid cell sample will ensure an easy, fast and possibly automated preparation of the sample for analysis. Furthermore, since the cells are easily uniformly distributed over the complete sample e.g. by shaking the sample vial with the liquid cell sample, there is no need to scan the sample over the whole thickness and a subsequent computational procedure for obtaining data of the cells' characteristics as averaged over the whole sample. In fact, the averaging of the cells' properties can be ensured by the uniform distribution of the cells over the complete liquid cell sample, whereby only a small part of the sample needs to be analyzed. Thusly, no time-consuming repositioning of the sample is needed to obtain holographic images over the whole thickness of the sample. Furthermore, using DDHM to perform the analysis allows a rapid, efficient and possibly automated replacement of the sample, since the sample is not introduced in between the interferometric components of the DHM system. In this case, the problem of disrupting the interferometer by the fast and automated replacement does not pose itself.

In a preferred embodiment, the step b) of the method for analyzing a liquid cell sample comprises the step of

c) illuminating in transmission and/or in reflection with illumination means said liquid cell sample and producing thereby a sample beam, whereby said illumination means preferably comprise spatially and temporally partially coherent light.

It is obvious that to take a holographic image, one needs to provide illumination means. However, in the present embodiment, the light from these illumination means may comprise spatially and temporally partially coherent light, in contrast with prior art DHM methods, which only provided highly correlated laser light. Spatially and temporally partially coherent light can be produced by e.g. a LED. A LED is cheaper than a laser and produces light with a spectrum centered around a known wavelength, which is spatially and temporally partially coherent, i.e. not as coherent as laser light, but still coherent enough to produce holographic images of the quality which is necessary for the applications at hand. LEDs also have the advantage of being available for many different wavelengths and are very small in size and easy to use or replace if necessary. Therefore, providing a method which can use spatially and temporally partially coherent light for obtaining holographic images will lead to more cost-effective devices for implementing such a method.

In a more preferred embodiment, the step b) of the method for analyzing a liquid cell sample comprises the steps of
d) generating by means of the differential interferometer interfering beams from said sample beam;
e) adequately positioning and orientating the tilting means in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device;
f) detecting and recording the fringe interference image thus formed by the interfering beams on the sensor of the imaging device;
g) sending the interference image to processing means, such as a computer;
h) possibly acquiring other similar but different interference images following steps c-g from said sample by implementation of the phase-stepping method;
i) processing said interference image(s) so as to extract the optical amplitude and/or phase of the sample by implementation of the phase stepping method or the Fourier transform data processing; and
j) computing said data linked to the cells in the sample from said optical amplitude and/or phase of said liquid cell sample.

In a preferred embodiment, the method for analyzing a liquid cell sample comprises the steps of
k) providing at least once a test sample in a test sample vial;
l) illuminating in transmission and/or in reflection with illumination means said test sample and producing thereby a test sample beam, whereby said illumination means preferably comprise spatially and temporally partially coherent light;
m) generating by means of the differential interferometer interfering beams from said test sample beam;
n) adequately positioning and orientating the movable part of the interferometer so as to equalize the optical length of said interfering beams with an accuracy in the range of less than the maximum wavelength of the illumination means to a few maximum wavelengths by means of the moving means.

These steps provide a way of calibrating the system for analyzing a liquid cell sample, and can be performed multiple times, i.e. calibration can be done whenever it is deemed necessary.

To improve the fast, reliable, accurate and automated analysis of a large number of liquid cell samples, in a preferred embodiment step a) of the method for analyzing a liquid cell sample comprises the steps of
d) placing at least one sample vial with a liquid cell sample in a movable sample vial holder;
e) positioning said sample vial holder with said sample vial such that said liquid cell sample can be illuminated by said illumination means.

It should be clear that such steps improve the speed at which a liquid cell sample in a sample vial can be positioned correctly for subsequent analysis. Furthermore, a sample vial is more easily replaced by the next sample vial when the sample vial is first placed in a sample vial holder, and only then positioned, preferably in an automated way, for analysis.

The present invention allows investigating samples with stronger optical phase distortions, and the accurate optical length adjustment of the interferometric arms is performed independently upon the sample and once said adjustment has been made, the system is ready to be used for every sample.

In a preferred embodiment, the microscope further comprises an electronic two-dimensional imaging device such as a CCD or CMOS camera, said electronic two-dimensional imaging device including a sensor and being defined by a pixel size and a number of pixels in one dimension. Said imaging device is arranged in the microscope so that its sensor is located in the back focal plane of the focusing means.

Preferably, the microscope also comprises processing means such as a computer. It should be noted that the microscope is also able to work with fluorescent samples either in transmission or in reflection mode.

Holography is an optical method to record and reconstruct three-dimensional images of samples. The hologram is recorded with the electronic image device as for example a CCD or CMOS camera. The signals recorded by the DDHM are sent to computer processing and image analysis means, for processing the said signals. The holographic reconstruction is performed such as to implement the wave optics propagation equations in order to investigate the three-dimensional image in depth.

A range of data is obtained through the processing of these signals, which correlate to the status of the biological sample and more specifically give information on the characteristics of the cells present in the biological sample. The said range of data may include amongst others the size of a cell, the morphology of a cell, the number of cells, cell density, the ratio between nucleus and cytoplasm of a cell and the optical density of a cell present in the said liquid cell sample. The data obtained by DDHM is subsequently compared and correlated with a reference database comprising a vast set of well-known cellular parameters. The term “reference database” as used herein refers to any suitable collection of data comprising information on at least one of the above mentioned parameters, including cell size, cell morphology, number of cells in a defined area, optical density of the nucleus of cell, ratio between cytoplasm and nucleus of a cell, color of a cell, color of a nucleus, color of a cell wall, number and form of internal cellular structures like the number and form of vacuoles, the number and form of mitochondria, division related structures like chromosomal structures, form, size, morphology of the nucleus and/or the location of the nucleus within the cell, association of cells, the degree of independence of cells, volume of a cell, proportion of the length of the cell wall to the cell size, number of identical or similar cells in an image, or number of ruptures, fissures, holes or visible pores in a cell. The corresponding information may be stored in any suitable format and may be accessed during and/or after the step of establishing the cellular parameter according to the present invention. The comparison process may be carried out automatically, e.g. by a data processing unit, a computer or an electronic device performing an algorithm to compare said data with a database of known cellular parameters. Alternatively, the parameters may be compared manually, i.e. by an operator.

The reference parameters or the reference information may additionally or alternatively be stored in the form of predefined threshold values, which allow a fast and reliable comparison of measured values with predefined default values, e.g. of specific cell or tissue type. Once such threshold values are not met, an alert or information signal may be generated informing the practitioner or operator about a sub-optimal or not met parameter criterion.

In a preferred embodiment, the system will provide a digital report and image of the sample, based on the data collected by the DDHM and the comparison of the data with the said reference database.

In order for the system to maintain an association between each sample vial and its corresponding derivatives thereof (such as the data obtained by the DDHM, the digital report and the digital image), an identification correlation system is provided. In accordance with one embodiment of the present invention, identifying indicia are provided on the sample vial in order to prepare a derivative from a sample vial. In a most preferred embodiment, these identifying indicia may comprise a bar code label, which corresponds to and uniquely identifies the vial and the sample contained therein. In another embodiment, the indicia may comprise an RFID tag. The indicia are read by identifying means, such as a laser scanner bar code reader in the case of the indicia being a bar code, or a RFID reader in the case of the indicia being an RFID tag, so that the particular vial can be identified. A processor linked to the reader, will then provide instructions so that all corresponding derivatives of the sample receive a corresponding indicia. Additionally, a date/time stamp may be enabled to print the date and time the data was collected, in addition to the initial sample indicia. Optionally, the name or other identifier of the cytological laboratory analyzing the sample with the system may be linked to the obtained data as well.

While there have been described herein what are to be considered exemplary and preferred embodiments of the present invention, other modifications of the invention will become apparent to those skilled in the art from the teachings herein.

1. A method for analyzing a liquid cell sample, comprising the steps of:
a) providing at least one liquid cell sample in a sample vial;
b) obtaining data linked to the cells in the sample by performing differential digital holographic microscopy with a differential interferometer on said liquid cell sample in said sample vial,
whereby cells in said liquid cell sample are suspended in a solution whereby said solution comprises an anti-clumping agent.

2. Method according to claim 1, whereby said cells comprise a tissue sample, a biopsy sample, a brushing or scraping sample from oral cavities, nipple secretions, skin lesions, eye brushings, a fine-needle-aspiration sample, a smear sample, a mucoid specimens taken from respiratory or gastrointestinal tracts or body fluids such as serous effusions or urinary or cerebrospinal fluids.

3. Method according to claim 1, whereby said solution comprises a buffering component and an alcohol.

4. Method according to claim 1, whereby obtaining said data, comprises the steps of
c) illuminating in transmission and/or in reflection with illumination means said liquid cell sample and producing thereby a sample beam, whereby said illumination means preferably comprise spatially and temporally partially coherent light.

5. Method according to claim 4, comprising the steps of:
d) generating by means of the differential interferometer interfering beams from said sample beam;
e) adequately positioning and orientating the tilting means in the second interferometer arm (respectively in the first interferometer arm) for tilting the beam reflected by the second reflecting element (respectively first reflecting element) relatively to the beam reflected by the first reflecting element (respectively the second reflecting element) by a precise tilting angle in such a way to superpose the beam reflected by the first reflecting element (respectively the second reflecting element) and the beam reflected by the second reflecting element (respectively the first reflecting element) in the front focal planes of the focusing means thereby creating a precise shift between the interfering beams reflected and transmitted by the second beam splitter on the sensor of the electronic imaging device;
f) detecting and recording the fringe interference image thus formed by the interfering beams on the sensor of the imaging device;
g) sending the interference image to processing means, such as a computer;
h) possibly acquiring other similar but different interference images following steps c-g from said sample by implementation of the phase-stepping method;
i) processing said interference image(s) so as to extract the optical amplitude and/or phase of the sample by implementation of the phase stepping method or the Fourier transform data processing; and
j) computing said data linked to the cells in the sample from said optical amplitude and/or phase of said liquid cell sample.

6. Method according to claim 5, comprising the steps of:
k) providing at least once a test sample in a test sample vial;
l) illuminating in transmission and/or in reflection with illumination means said test sample and producing thereby a test sample beam, whereby said illumination means preferably comprise spatially and temporally partially coherent light;
m) generating by means of the differential interferometer interfering beams from said test sample beam;
n) adequately positioning and orientating the movable part of the interferometer so as to equalize the optical length of said interfering beams with an accuracy in the range of less than the maximum wavelength of the illumination means to a few maximum wavelengths by means of the moving means.

7. Method according to claim 1, whereby said data comprises cell density, cell morphology, cell size, the ratio between nucleus and cytoplasm of a cell and/or the optical density of a cell present in the said liquid cell sample.

8. Method according to claim 1, whereby said data obtained by differential digital holographic microscopy are compared and correlated with a reference database comprising a set of cellular parameters.

9. Method according to claim 8, whereby a digital report and image of said liquid cell sample is created based upon said data obtained by digital holographic microscopy and said correlation of said data with reference database of known cellular parameters.

10. Method according to claim 1, whereby providing said at least one liquid cell sample in a sample vial comprises the steps of:
o) placing at least one sample vial with a liquid cell sample in a movable sample vial holder;
p) positioning said sample vial holder with said sample vial such that said liquid cell sample can be illuminated by said illumination means.

11. Method according to claim 10 wherein the sample vial thickness is larger than the positioning precision of the movable sample vial holder and the sample vial holder is placed such that the focal plane of the objective lens of the differential digital holographic microscope lies in the vial.

12. Method according to claim 1, whereby at least 20% of the cells in said liquid cell sample are single cells.

13. Method according to claim 1, comprising the step of shaking said sample, preferably prior to and/or during the step of obtaining said data by performing differential digital holographic microscopy.

14. A system for analyzing a liquid cell sample, comprising:
(i) a differential digital holographic microscope comprising illumination means, a differential interferometer and a digital recording device connected to a processing device such as a computer;
(ii) at least one exchangeable sample vial comprising a liquid cell sample, wherein cells are suspended in a solution whereby said solution comprises an anti-clumping agent;
(iii) a movable sample vial holder;
characterized in that
(iv) said sample vial holder is adapted to receive said sample vial;
(v) said sample vial holder is adapted to position said sample vial such that the focal plane of the objective lens of said differential digital holographic microscope lies in the vial.

15. System according to claim 14, whereby said sample vial comprises a material which is transparent for the illumination beam of said illumination means, or said sample vial has identifying indicia, preferably fixed indicia or programmable indicia.

16. System according to claim 14, comprising a data processing unit, a computer or an electronic device which is capable of performing an algorithm to compare data obtained by said differential digital holographic microscope with a reference database of cellular parameters.

17. System according to claim 16, comprising a computer or printer capable of providing a report based on the comparison of said data and said reference database, whereby said report is correlated with said indicia on said sample vial.
